(19) United States
(12) Patent Application Publication
(10) Pub. No.: US 2007/0132140 A1
(43) Pub. Date: Jun. 14, 2007

(54) Method for making a baseball bat of composite material

(76) Inventor: Li-Tu Lin Wu, Taichung (TW)

Correspondence Address: HERSHKOVITZ & ASSOCIATES, 2845 DUKE STREET, ALEXANDRIA, VA, 22314, US

(21) Appl. No.: 11/297,443

(22) Filed: Dec. 9, 2005

(51) Int. Cl. B29C 70/00

(52) U.S. Cl. 264/257

(57) ABSTRACT

A method for making a baseball bat includes the steps of preparing a solid bar made of silicone and having a tapered body with a first end and a second end provided with a diameter larger than that of the first end, wrapping a layer of composite fiber around the solid bar, placing the combination of the solid bar and the composite fiber layer into a mold, heating and pressurizing the combination of the solid bar and the composite fiber layer to expand the solid bar as well as the composite fiber layer, curing the combination of the solid bar and the composite fiber layer to allow the solid bar to return to its original dimension and removing the solid bar from the composite fiber layer and capping the composite fiber layer with a cover.

### BACKGROUND OF THE INVENTION

1. Field Of The Invention

The present invention relates to a method for making a baseball bat, and more particularly to a method for making a baseball bat of composite material.

2. Description Of The Prior Art

A baseball bat made of wood or of aluminum has already been in the market for years. As the baseball industry progresses along with the scientific innovation, a baseball bat made of composite material, such as carbon fiber or glass fiber, is also introduced to the market to improve the batting effect. To make the baseball bat, the user has to immerse the selected fiber in a resin solution so as to form a pre-finished base. Then the base is wrapped around a nylon tube after cut into a predetermined shape. After the aforementioned process is finished, the combination of the base and the nylon tube is placed into a mold for heating and pressurizing. During the heating and pressurizing process, the nylon tube will gradually expand, which in turn allows the. base wrapped around the nylon tube to form a baseball bat. During the expansion of the nylon tube, the expansion speed in each portion of the nylon tube is not the same such that the thickness of the nylon tube after expansion is not uniform, which leads to the conclusion that the thickness of the baseball bat is not uniform. As a result, when the user is using the baseball bat to hit a baseball, either the baseball bat deforms or the travel distance of the ball is not the same even the force of swing is the same.

To overcome the shortcomings, the present invention tends to provide an improved method for making a baseball bat to mitigate the aforementioned problems.

### SUMMARY OF THE INVENTION

The primary objective of the present invention is to provide a method for making a baseball bat of composite material.

In order to accomplish the aforementioned objective, the method of the present invention includes the steps of:

preparing a solid bar made of silicone and having a tapered body with a first end and a second end provided with a diameter larger than that of the first end;

wrapping a layer of composite material around the bar;

placing the combination of the bar and the composite material layer into a mold;

heating and pressurizing the combination of the bar and the composite material layer to expand the solid bar;

curing the combination of the bar and the composite material layer; and

removing the solid bar from the composite material layer and capping the composite material layer with a cover.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional view of a baseball bat made of a composite material;

FIG. 2 is a flowchart showing the steps of the method of the present invention;

FIG. 3 is a schematic view showing how the steps in FIG. 2 are performed; and

FIG. 4 is a schematic cross sectional view showing a different embodiment of the baseball bat of the present invention.

### DETAILED DESCRIPTION OF THE PREFERRED EMBODIMENT

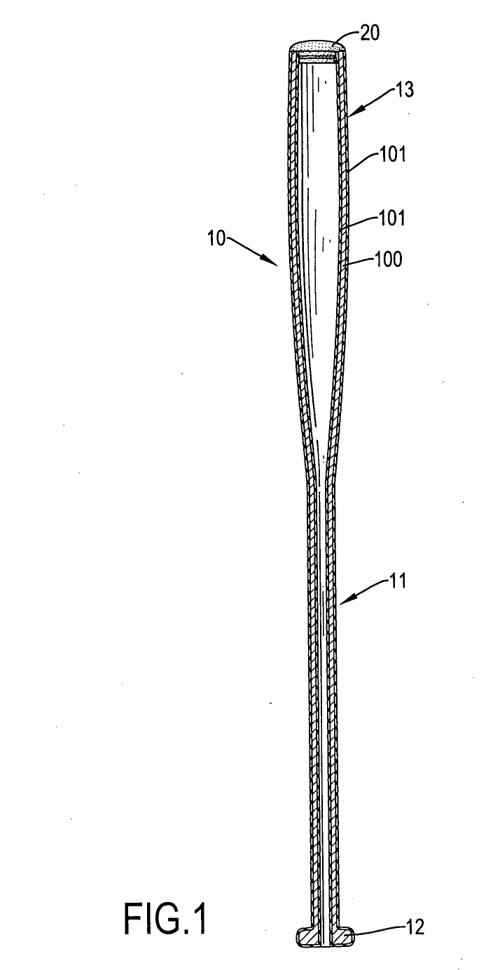

With reference to FIG. 1, it is noted that the hollow baseball bat (10) in accordance with the present invention includes a holding section (11) and a batting section (13) integrally formed with the holding section (11). The holding section (11) has an annular head (12) formed on a free end of the holding section (11) and the batting section (13) has a cover (20) provided to close an opening defined in a free end thereof. Furthermore, the wall of the baseball bat is composed of a composite fiber layer (100) and a resin layer (101) provided on both sides of the composite fiber layer (100).

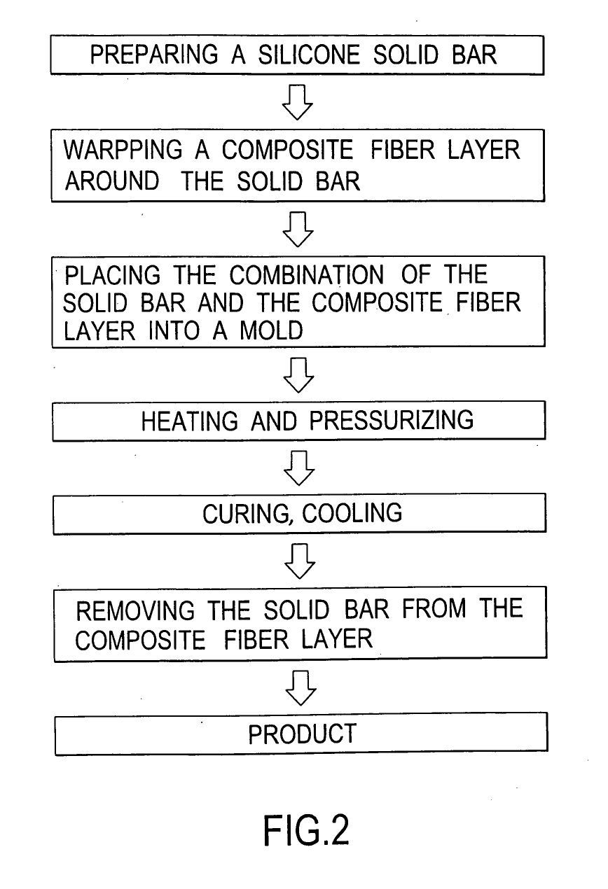

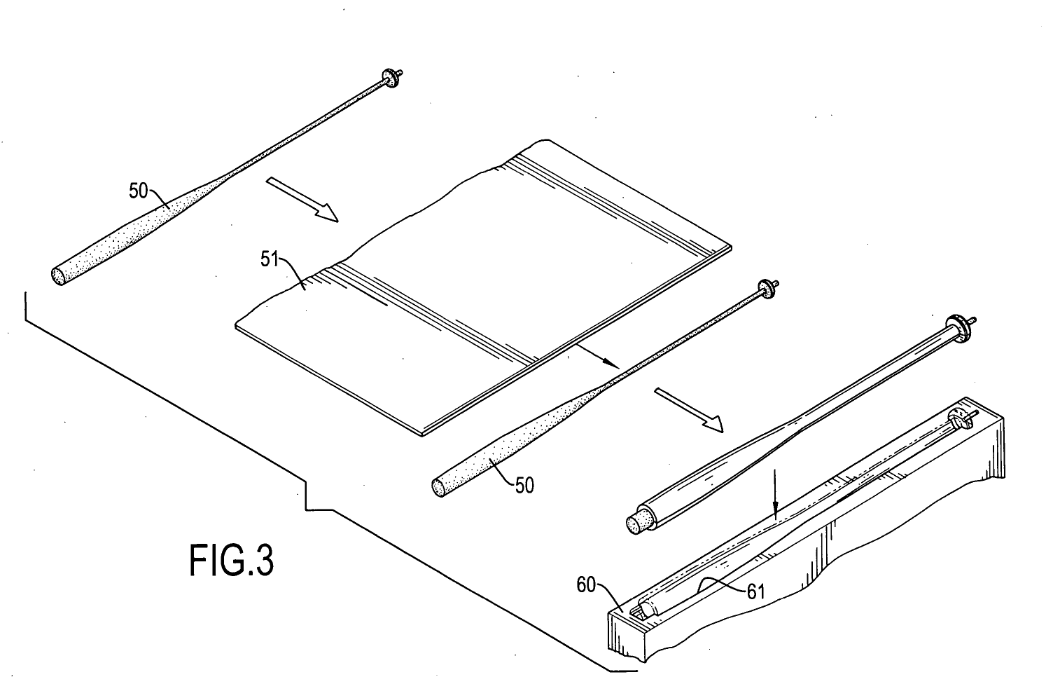

With reference to FIGS. 2 and 3, it is noted that the method of the present invention includes the steps of:

preparing a solid bar (50) made of silicone and having a tapered body with a first end and a second end provided with a diameter larger than that of the first end;

The first section is the same as that of the holding section (11) and the second section is the same as the of the batting section (13), wherein the first section is provided with an annular head (12) and the second section is not yet provided with a cover (20), which is entirely the same as the structure as shown in FIG. 2. Yet the entire length of the bar (20) is longer than that of the hollow baseball bat (10).

wrapping a composite material layer (51) around the bar (50);

A composite fiber layer (51) is applied to and wrapped around the solid bar (50).

placing the combination of the solid bar (50) and the composite fiber layer (51) into a cavity (61) of a mold (60);

heating and pressurizing the combination of the solid bar and the composite fiber, layer (51) to expand the solid bar (50);

When the solid bar made of silicone is expanded due to heating, the composite fiber layer (51) is forced to expand as well. Because the expansion rate of silicone is uniform, the composite fiber layer (51) is expanded uniformly.

curing the combination of the solid bar (50) and the composite fiber layer (51);

When the expanded solid bar (50) is undergone a curing process, the originally expanded body is cooled down and the size thereof is then returned to its original size, which results in that the composite fiber layer (51) has a dimension larger than that of the solid bar (50).

removing the solid bar (50) from the composite fiber layer (51) and capping the composite fiber layer (51) with a cover.

After the solid bar (50) is retracted from the hollow composite fiber layer (51), an initial baseball bat made of composite fiber is formed and ready for use.

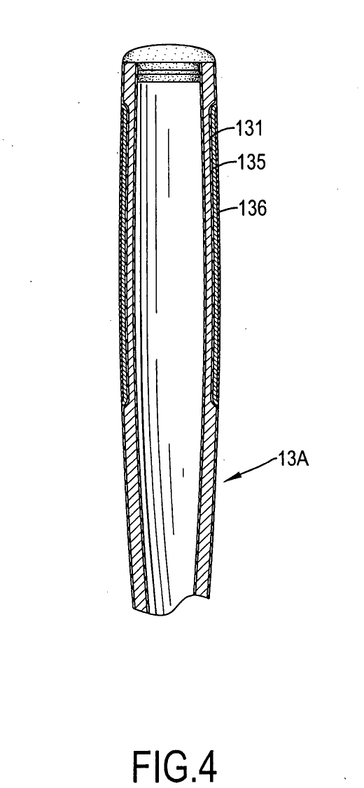

With reference to FIG. 4, it is noted that the batting section (13A), the second section, is provided with a recess (131). A composite material fiber bundle (135) is applied to the recess (131) and then a resin layer (136) is applied to cover the composite material fiber bundle (135) to accomplish the goal of seamless feature with the reinforced composite material fiber bundle (135).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for making a baseball bat, the method comprising the steps of:
preparing a solid bar made of silicone and having a tapered body with a first end and a second end provided with a diameter larger than that of the first end;
wrapping a layer of composite fiber around the solid bar;
placing the combination of the solid bar and the composite fiber layer into a mold;
heating and pressurizing the combination of the solid bar and the composite fiber layer to expand the solid bar as well as the composite fiber layer;
curing the combination of the solid bar and the composite fiber layer to allow the solid bar to return to its original dimension; and
removing the solid bar from the composite fiber layer and capping the composite fiber layer with a cover.

2. The method as claimed in claim 1, wherein the composite fiber layer has a recess defined in an outer periphery thereof to receive therein a layer of composite fiber bundle and a resin layer
